(19) United States
(12) Patent Application Publication
(10) Pub. No.: US 2003/0095632 A1
(43) Pub. Date: May 22, 2003

(54) X-ray tube cathode cup structure for focal spot deflection

(75) Inventors: Allan D. Kautz, Naperville, IL (US); Salvatore D. Perno, Winfield, IL (US)

Correspondence Address: Thomas E. Kocovsky, Jr., FAY, SHARPE, FAGAN, MINNICH & McKEE, LLP, Seventh Floor, 1100 Superior Avenue, Cleveland, OH, 44114-2518, US

(73) Assignee: PHILIPS MEDICAL SYSTEMS (CLEVELAND), INC.

(21) Appl. No.: 09/989,864

(22) Filed: Nov. 20, 2001

(51) Int. Cl. H01J 35/30

(52) U.S. Cl. 378/137

(57) ABSTRACT

A cathode assembly (18) for an x-ray tube (1) includes a base (60) to which a filament (70) is mounted. A pair of deflectors (82, 84) are carried by the base for deflecting a beam (A) of electrons generated by the filament. Metal tubes (130, 132) are mounted in bores (106) of insulator blocks (104, 105). Metalized ends (150) of the insulator blocks are brazed into bores (122) in the base. A rod (130, 132) attached to the deflector is slid into the tube and the deflector's position and alignment are gauged and accurately set. The rod and tube are crimped to set the deflector position then welded.

### BACKGROUND OF THE INVENTION

The present invention pertains to the vacuum tube arts, and in particular to an x-ray tube cathode cup structure for deflecting a focal spot of a beam of electrons. It finds particular application in conjunction with rotating anode x-ray tubes for CT scanners and will be described with particular reference thereto. However, it is to be appreciated that the present invention will also find application in the generation of radiation and in vacuum tubes for other applications.

Conventional x-ray tubes include a vacuum enclosure and a source of a beam of electrons in the form of a cathode. The cathode includes a heated filament which emits electrons. The impact of the electron beam on the anode causes a beam of x-radiation to be emitted from the x-ray tube, typically through a beryllium window. A trend toward shorter x-ray exposure times in radiography has placed an emphasis on having a greater intensity of radiation and hence higher electron currents. Increasing the intensity can cause overheating of the x-ray tube anode. An electrical bias voltage is applied to the beam of electrons in order to control, to some extent, the size of the focal spot.

One way to control the size of the focal spot of the electrons on the anode more closely is to mount the cathode filament within a cathode focusing or support cup member. Such a system is shown in U.S. Pat. No. 4,689,809. A cathode cup is split into two portions, surrounding the filament. The portions are biased equal to or negative with respect to the filament. The biased cup reduces unwanted “wings,” or diffused areas, appearing as part of the x-ray focal spot.

Other cathode cup and filament arrangements for controlling the size and shape of the electron focal spot on the tube anode are discussed in U.S. Pat. Nos. 4,685,118, 5,224,143, and 5,065,420.

To minimize the power requirements of the focussing system and to maintain accurate positioning of the filament relative to the deflectors, it is desirable to mount both the deflectors and the filament to the same support. Cathode cups thus typically include a base or arm portion which supports the filament and a pair of deflectors. The deflectors are mechanically mounted to the base, but are electrically insulated from it. This is achieved through the use of ceramic insulators which are brazed to both the base and the deflectors in the form of a sandwich. The ceramic insulators include central bores through which a bolt is received for maintaining alignment of the components during brazing. To avoid shorting, the bolt is electrically isolated from the base. Such a cathode cup design is difficult to assemble, difficult to align, and is susceptible to shorting. This can occur if the material used to braze the ceramic insulator to the base or the deflector flows into the insulator bore that receives the bolt. Shorting can also occur due to natural plating of the ceramic insulator with metal vapor from the filament.

The present invention provides a new and improved x-ray tube and method which overcomes the above-referenced problems and others.

### SUMMARY OF THE INVENTION

In accordance with one aspect of the present invention, a cathode assembly is provided. The assembly includes a base. A filament is mounted to the base for delivering a stream of electrons. A deflector is carried by the base for focusing the stream of electrons. An insulator electrically insulates the deflector from the base. The insulator defines a bore. A rod is connected with the deflector adjacent a first end of the rod. The rod is received within the insulator bore.

In accordance with another aspect of the present invention, an x ray tube is provided. The x-ray tube includes an envelope which encloses an evacuated chamber. A cathode assembly is disposed within the chamber for providing a source of electrons. The cathode assembly includes a base supported in the envelope. A filament is mounted to the base for providing the electrons. A deflector is carried by the base for focusing the electrons into a beam. An insulator electrically insulates the deflector from the base. The insulator defines a bore. A rod is connected with the deflector adjacent a first end of the rod, the rod being received within the insulator bore. An anode is disposed within the chamber and positioned to be struck by the electrons and generate x-rays.

In accordance with another aspect of the present invention, a method of assembling a cathode assembly is provided. The method includes attaching at least one rod to at least one deflector and attaching a metal tube in an insulator to define a bore for receiving the rod. The insulator is attached to a base. A filament assembly is attached to the base. The method further includes sliding the rod into the tube to mount the deflector to the base and attaching the rod to the tube.

One advantage of at least one embodiment of the present invention is that a cathode cup is electrically isolated from a filament.

Another advantage of at least one embodiment of the present invention is that deflectors of a cathode cup are readily aligned with a filament.

Another advantage of at least one embodiment of the present invention is that components of a cathode cup are accurately aligned.

Another advantage of at least one embodiment of the present invention is that deposition of vaporized filament material on to insulators which space the deflectors from a base assembly is minimized by reducing the line of sight between the filament and the insulators.

Still further advantages of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

FIG. 1 is a schematic sectional view of a rotating anode x-ray tube according to the present invention;

FIG. 2 is a side view of a cathode assembly of the x-ray tube of FIG. 1;

FIG. 3 is a front perspective view of the cathode assembly of FIG. 2;

FIG. 4 is a top view of the cathode assembly of FIG. 2;

FIG. 5 is a sectional view of the cathode assembly through line B-B of FIG. 4; and

FIG. 6 is an exploded perspective view of the cathode assembly of FIG. 2.

### DETAILED DESCRIPTION OF THE PREFERRED EMBODIMENTS

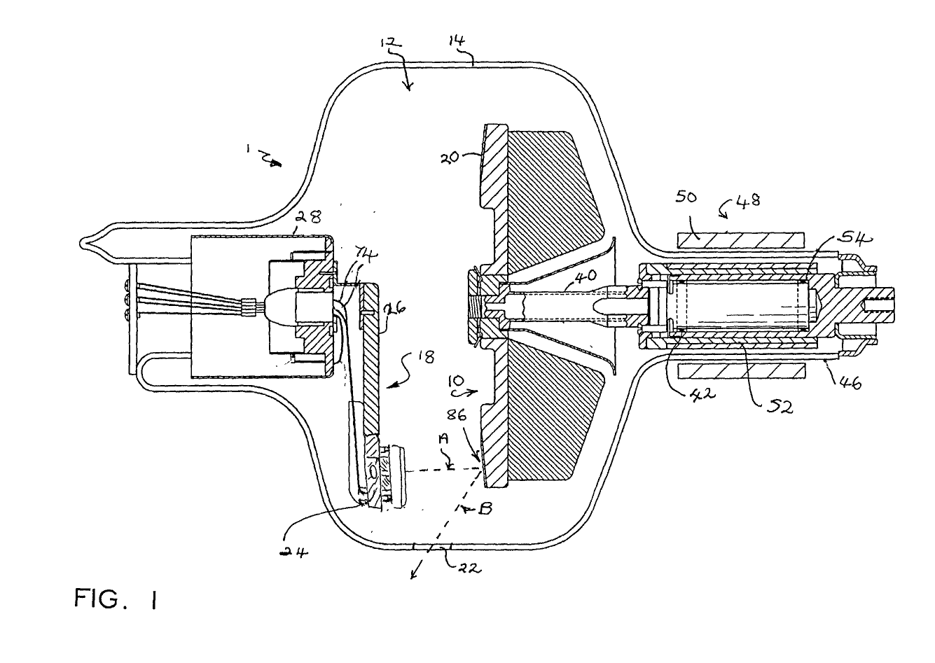

With reference to FIG. 1, a rotating anode x-ray tube 1 of the type used in medical diagnostic systems for providing a beam of x-ray radiation is shown. The tube includes an anode 10 which is rotatably mounted in an evacuated chamber 12, defined by an envelope or frame 14. A heated element cathode assembly 18 supplies and focuses an electron beam A. The cathode is biased, relative to the anode 10 such that the electron beam flows to the anode and strikes a target area 20 of the anode. A portion of the beam striking the target area is converted to x-rays B, which are emitted from the x-ray tube through a window 22 in the envelope. The cathode assembly includes a cathode cup or head 24, which is supported in the envelope by an arm 26 of a cathode support assembly 28.

The target 20 of the anode is connected to a shaft 40, which is supported by bearings 42 in a neck portion 46 of the evacuated envelope 14 and driven by an induction motor 48. The induction motor includes a stator 50, outside the envelope, which rotates a rotor 52 connected to the shaft relative to a stationary bearing housing 54. The anode is rotated at high speed during operation of the tube. It is to be appreciated that the invention is also applicable to stationary anode x-ray tubes, rotating cathode tubes, and other electrode vacuum tubes.

With reference now to FIGS. 2-6, the cathode head 24 includes a base 60, which may be integrally formed with the arm 26 or mounted thereto, for example, with bolts 62 or other suitable attachment members threaded through holes 64 in the base (FIG. 4). A filament 66 is supported by the base. FIG. 3 shows two filament supports 67, 67′ received through corresponding bores 68, 68′, which extend axially through the base such that an electron-emitting portion or tip 70 of the filament is spaced from the base. The filament may be fixed in this position by brazing the filament supports 67, 67′ to the bore or by other means, such as threading a threaded portion of the filament supports 67, 67′ to corresponding threads in the respective bore. It will be appreciated that two or more filaments may be used in place of the single filament shown, if desired. The filament is connected by conductors 74 to a suitable power source 76 outside the envelope (FIG. 3). Although a wire filament is illustrated, it is to be understood that other electron sources are also contemplated, including thin film filaments, and the like.

Deflectors 80, 82 are carried by the base 60 in a manner which electrically insulates the deflectors from the base. Two deflectors are shown in FIG. 3, although a single deflector, or more than two deflectors, could alternatively be used. The deflectors are positioned in close proximity to the filament tip 70 for deflecting and/or focussing the beam of electrons emitted by the filament. This allows the size and location of a focal spot 86 on the target (FIG. 1) to be controlled and adjusted.

As shown in FIG. 3, the deflectors 80, 82 are generally mirror images of each other and are positioned on opposite sides of the filament tip 70. Each deflector has an upper surface 90 and lower surface 92 (the terms “upper” and “lower” being used with reference to the orientation shown in FIG. 3, the upper surface being closer to the base 60). A side wall 94 of the deflector projects inwardly, towards the filament, in the region of the filament tip 70, thus providing a relatively narrow gap 96 between the two deflectors in the region of the filament tip.

The deflectors 80, 82 may be formed from molybdenum, or other suitable temperature resistant, electrically conductive material. The base 60 may also be formed from molybdenum, or may be formed from less expensive, easier to machine materials, such as nickel, since it does not need to withstand as high temperatures as the deflector.

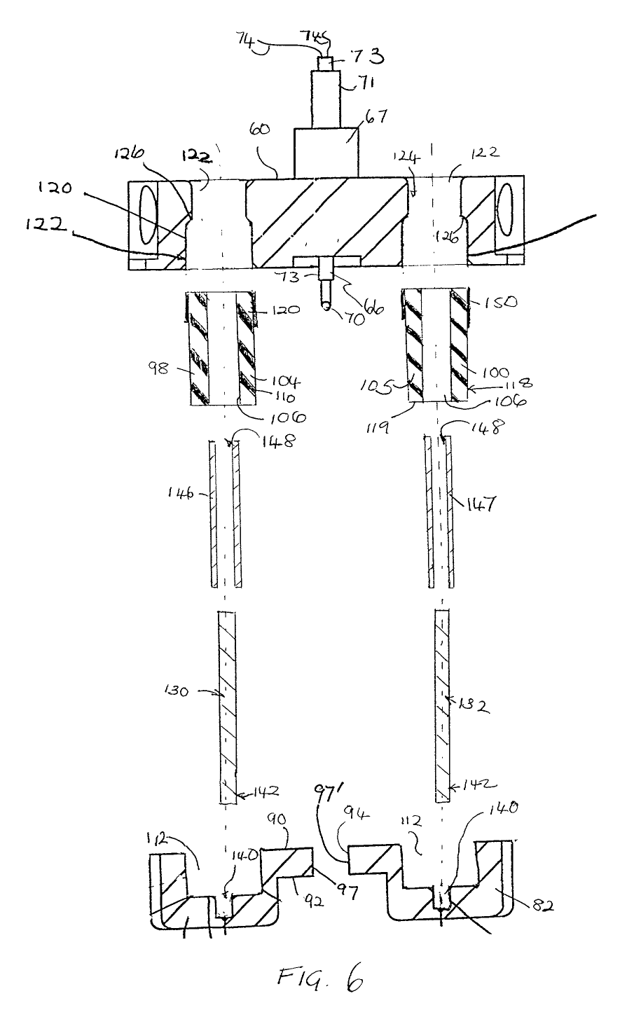

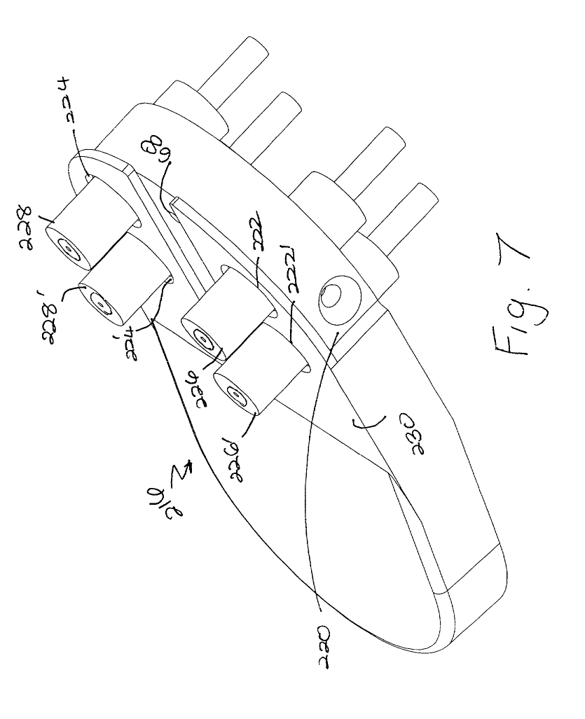

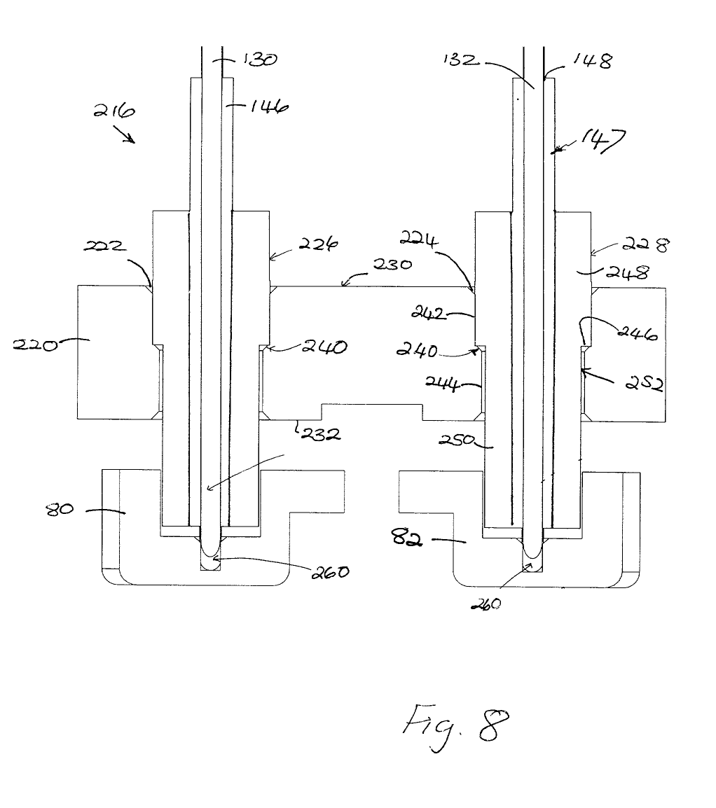

With particular reference to FIGS. 4 and 6, the deflectors 80, 82 are spaced and insulated from the base by insulators 98, 100, 98′, 100′. As shown in FIG. 4, four insulators are employed, two for each deflector. For stability, it is preferable to use two (or more) insulators for each deflector, spaced longitudinally from each other, although it will be appreciated that a single insulator may be used. For ease of reference, the cathode will be described with reference to two deflectors, each having two insulators. As shown in phantom in FIG. 4, the filament tip 70 extends between forward and rear posts 67, 67′ along a line which is generally coincident with the longitudinal axis of the base 60 and perpendicular to a line B-B between the forward pair of insulators 98, 100 and is equally spaced from each insulator 98, 100, 98′, 100′ at its closest point thereto.

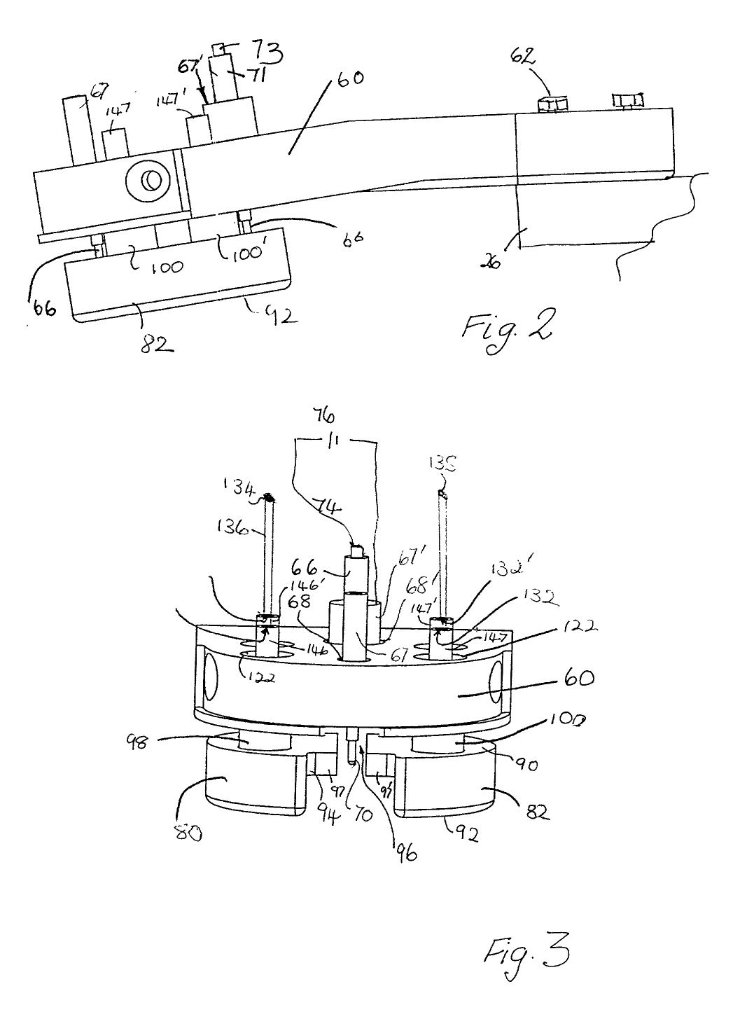

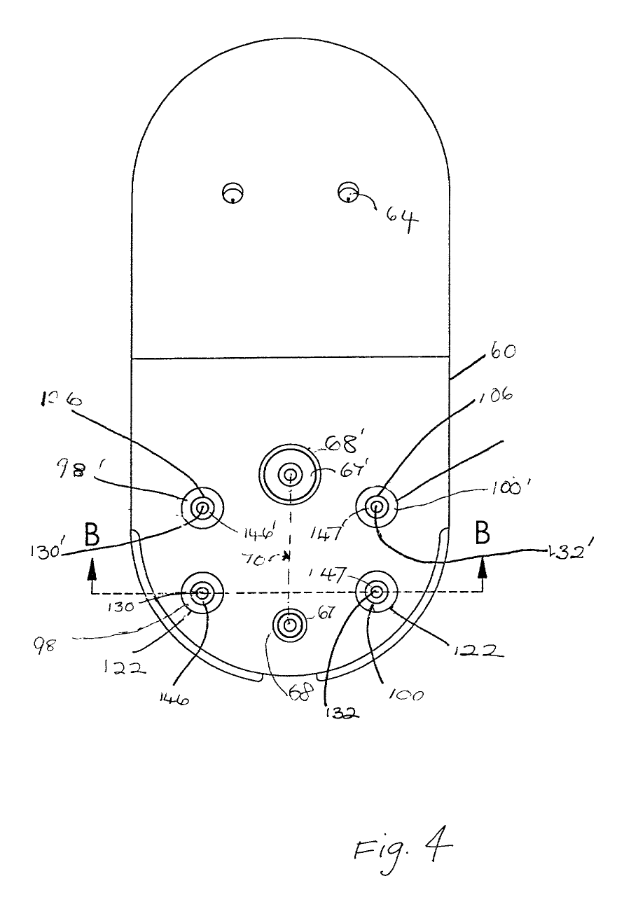

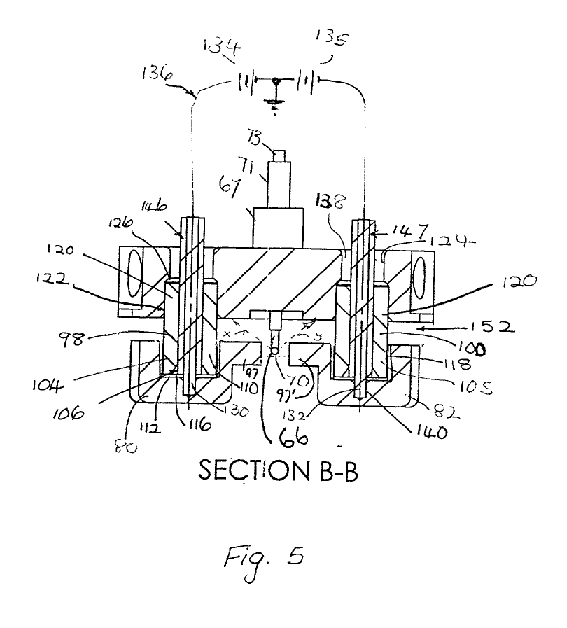

As best shown in FIGS. 5 and 6, each insulator 98, 100, 98′, 100′ comprises a cylindrical block 104, 105, each with a central axial bore 106. A first, lower portion 110 of each block 104 is received within a correspondingly shaped cylindrical socket 112 in the deflector 80, 82. It will be understood that different shaped insulator blocks may be used, such as rectangular blocks and a corresponding shaped socket in the defector provided. As will be appreciated, two sockets are formed in each deflector to receive corresponding insulator blocks, a total of four sockets in all. Each socket extends partway into the deflector, preferably, about half way.

The socket 112 has a slightly larger diameter than the corresponding block 104, 105, such that a gap 116 spaces the insulator from the deflector adjacent a cylindrical side 118 and preferably also a base 119 of the insulator. The gap 116 is preferably about 70-100 microns in width, such that a space is maintained between the insulator 104, 105, 104′, 105′ and the deflector 80, 82. This reduces the risk of shorting out. In service, insulators sometimes become coated with a plating layer formed by evaporation of filament material. Leaving a gap between the insulator and the deflector allows for a fairly thick layer of plating material to accumulate without resulting in shorting out.

A second (upper in FIG. 6) portion 120 of each insulator block 104, 105 is received within a cylindrical passageway 122 in the base (four passageways are shown in FIG. 4). The passageway 122 is chamfered to create a smaller diameter portion 124 at the upper end thereof with a shoulder 126 for providing an upper stop for the insulator block 104, 105.

The insulator blocks 104, 105 are formed from an electrically insulating material, such as alumina. For example, 94% purity or 99% purity alumina may be used, such as AD 94, AL 500, or equivalent purity. Al₂O₃ meeting ASTM Standard D2442 Type 4 is an exemplary insulating material. For effective electrical insulation of the deflector from the base (and the filament), the insulators preferably provide a resistance of at least 720 giga-ohm.

A pair of rods 130, 130′, 132, 132′, formed from an electrically conductive material, such as niobium, are mounted to each deflector 80, 82 (i.e., four rods in total) and are received through the corresponding bore 106 of the insulator blocks 104, 105. The rods 130, 130′, 132, 132′ are electrically connected to a respective bias supply 134, 135 by suitable wiring 136 (FIG. 3). One bias supply is preferably provided for each deflector. The rod is electrically insulated from the base 60 by the corresponding insulator block 104, 105 and by a gap 138 at the upper end 124 of the insulator bore.

The rods 130, 130′, 132, 132′ provide an electrically conductive path to the respective deflector 80, 82 for biasing the deflector to an appropriate voltage for deflecting or focusing the electron beam. For example, as the two deflectors 80, 82 both become more negative, relative to the filament, the size of the focal spot is reduced. When they become sufficiently negative, the electron beam is turned off. If one deflector is more negative than the other, the focal spot moves away from the more negative part. This latter result can be achieved by biasing only one of the deflectors and having the other deflector at the same potential as the filament. Because of the close proximity of the deflectors to the filament, a small bias is able to deflect or focus the beam. The two bias supplies 134, 135 may be computer controlled to permit automatic control of the width and positioning of the focal spot to a multiplicity of locations.

Each rod 130, 130′, 132, 132 is preferably brazed to the deflector prior to insertion of the rod in the corresponding insulator block bore 106. As shown in FIG. 6, each deflector has a central hole 140 machined in the base of each socket 112, and shaped to receive one end 142 of the respective rod 130, 130′, 132, 132. To attach the rod to the deflector, the rod is positioned in the hole 140, together with a small piece of a suitable braze material, and the assembly heated to an appropriate temperature to braze the two components 130, 80 together. Other methods of attaching the rod 130, 132 to the deflector 80, 82 are also contemplated.

Each of the insulator blocks 104, 105 preferably has a cylindrical tube 146, 147, 146′, 147′ mounted axially in the central bore 106 for receiving the corresponding rod. Although only two tubes 146, 147 and two blocks are shown in the view of FIG. 6, it will be appreciated that a tube is provided for each insulator block. Thus, for this embodiment, four tubes 146, 147, 146′, 147′ are employed, as shown in FIG. 4. Each passageway, insulator bock bore, and corresponding tube and rod are preferably concentrically arranged, as shown in FIG. 4. As shown in FIG. 5, the tube 146, 147 has an upper end which extends beyond the upper end of the insulator block, when installed, and is preferably of sufficient length to extend above the base 60 when the insulator block 104, 105 is located in the base. At a lower end, the tube 146, 147, when installed, is preferably flush with the base 119 of the insulator block, or may be slightly set back within the block.

The tube 146, 147 has an axially extending bore 148 therethrough with an internal diameter which is only slightly larger than the diameter of the corresponding rod 130, 132 so that the rod fits snugly in the tube bore. For example, the rod 130, 132 may have an OD of 0.100 cm+0.000/−0.018 and the corresponding tube 146, 147 an ID of 0.104 cm+0.025/−0.000. The tube is preferably formed from a material which is readily welded to the rod, for example, by laser welding. Exemplary materials for forming the tube include nickel and Kovar™. The tube 146, 147 is attached to the insulator block 104, 105 by brazing the two parts together, for example, by heating the tube and block with a suitable braze material between them. The quantity of braze material used should be sufficient to attach the parts firmly, without overflowing significantly at ends of the insulator block. This step is preferably carried out prior to inserting the insulator block into the base passageway 122.

The insulators are brazed to the cup base 60 by heating the base and insulator, together with a suitable brazing material. The brazing material is preferably positioned in the shelf region. The brazing material can be the same type as is used to attach the tube to the insulator block and the rod to the deflector. However, since the brazing is preferably carried out in three separate steps (rod to deflector, tube to block, and block to base), the brazing material for each of the three joints can be a different material which is compatible with the parts to be joined and heated to an appropriate temperature for the respective braze material to melt.

To provide a suitable surface for brazing, the insulator block preferably has a very thin surface coating 150 of a metallizing material, such as a molybdenum-manganese or tungsten-manganese composite material (shown exaggerated in the thickness in FIG. 6). The coating may be deposited on the block by suitable deposition techniques to a thickness of about 5-20 microns. Preferably, the metallizing layer extends over only a portion of the outer surface of the blocks, such as at the upper end of the block in the region where the braze material will be applied, to minimize risk of shorting between the base and the deflector.

The insulator tubes 146, 147 are welded or otherwise attached to the rods 130, 132, for example, by laser welding. This step is preferably carried out after the insulators 104, 105 have been brazed into the base. This allows the deflectors to be properly aligned with the filament. The length of the rods 130, 132 is preferably selected such that, when the deflectors are correctly positioned, the rods are level with or protrude by a small amount from the upper ends of their respective tubes 146, 147.

To ensure alignment of the filament tip 70 with the deflectors, the filament posts 67 are preferably seated in the base before inserting the rods into the tubes. The filament posts are welded or otherwise fixed into the respective bore 68. The rods are then inserted into their respective tubes. A gauge (not shown) of the appropriate thickness is then inserted between the deflector and the base to determine an appropriate gap 152 between the deflector and the base. The base and deflector are pushed towards each other (the rods sliding in their respective tubes) until the base and deflector contact the gauge.

Prior to laser or otherwise welding the tubes to the rods, the respective tubes 146, 147 and rods 130, 132 are optionally crimped together to hold the desired set position. The two deflectors are preferably positioned so that the filament is approximately halfway between top and bottom surfaces of the deflector. This minimizes the risk of metallization of the insulator by material evaporating from the filament and avoids a “line of sight” being created in which material from the filament can travel in a straight line to the insulator. As can be seen from FIG. 5, the deflectors are positioned such that material evaporating from the filament tip 70 will be inhibited from traveling directly towards the insulator blocks, the closest direct paths x and y to the insulators 98, 100 taking the material to the base 60, rather than to the insulator.

A preferred method of assembling the cathode is thus as follows:

a) braze the rods 130, 132 to the deflectors 80, 82,

b) braze the tubes 146, 147 to the insulator blocks 104, 105,

c) braze the insulator blocks to the base 60,

d) set the filament 66 into the base,

e) set the deflector height with a gauge and crimp the tubes 146, 147 to the rods 130, 132.

f) weld the tubes 146, 147 to the rods 130, 132.

As will be appreciated, step b) may alternatively be carried out before or concurrently with step a) and steps a), b), and/or c) may be carried out after step d).

Assembling the components stepwise, with three separate brazing steps a), b), c), and a welding step f), rather than brazing the insulator to the base and to the deflector in a single brazing operation, minimizes tolerance stackups due to improper alignment of the three components. The deflectors are easily aligned with respect to the filament tip, simply by sliding the rods up and down in their respective tubes. Having two (or more) tubes which fit snugly to the corresponding rods and thus guide their movement ensures that the deflector remains parallel with the base as it is being positioned.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiment, the invention is now claimed to be:

1. A cathode assembly comprising:
a base;
a filament mounted to the base for delivering a stream of electrons;
a deflector carried by the base for focusing the stream of electrons;
an insulator for electrically insulating the deflector from the base, the insulator defining a bore; and
a rod connected with the deflector adjacent a first end of the rod, the rod being received within the insulator bore.

2. The cathode assembly of claim 1, further including:
a second deflector supported by the base;
a second insulator for electrically insulating the second deflector from the base, the second insulator defining a second bore; and
a second rod, connected with the deflector adjacent a first end of the second rod, the second rod being received within the second insulator bore.

3. The cathode assembly of claim 1, further including:
another insulator for electrically insulating the deflector from the base, the other insulator defining another bore; and
another rod, connected with the deflector adjacent a first end of the rod, the other rod being received within the other insulator bore.

4. The cathode assembly of claim 1, further including a tube, mounted in the bore, which receives the rod.

5. The cathode assembly of claim 1, wherein the base defines a passageway, a first end of the insulator being received in the passageway.

6. The cathode assembly of claim 5, wherein the passageway includes a first portion and a second portion, the second portion having a larger internal diameter than the first portion such that a shoulder is defined between the first and second portions, the insulator having a portion of larger diameter than the first portion of the passageway which is received in the second portion of the passageway.

7. The cathode assembly of claim 1, wherein the deflector defines a socket which receives a second end of the insulator.

8. The cathode assembly of claim 7, wherein the deflector defines a hole which extends into the deflector from the socket, the hole receiving the first end of the rod.

9. The cathode assembly of claim 8, wherein the deflector socket has a larger diameter than a diameter of the insulator, such that a gap is defined between the socket and a side wall of the deflector.

10. The cathode assembly of claim 1, wherein the deflector defines a well which receives the first end of the rod.

11. The cathode assembly of claim 1, wherein the insulator has a metallized coating on a first portion thereof, the insulator being brazed or welded to the base at the metallized coating.

12. The cathode assembly of claim 1, wherein the rod electrically connects the deflector with a source of electrical potential for biasing the deflector.

13. The cathode assembly of claim 1, wherein the deflector is configured and positioned to eliminate a direct line of sight for the flow of vaporized filament material between the filament and the insulator.

14. An x-ray tube comprising:
an envelope which encloses an evacuated chamber;
a cathode assembly disposed within the chamber for providing a source of electrons, the cathode assembly including:
a base supported in the envelope,
a filament mounted to the base for providing the electrons,
a deflector carried by the base for focusing the electrons into a beam,
an insulator for electrically insulating the deflector from the base, the insulator defining an internal bore, and
a rod connected with the deflector adjacent a first end of the rod, the rod being received within the insulator bore; and
an anode disposed within the chamber positioned to be struck by the electrons and generate x-rays.

15. A method of assembling a cathode assembly comprising:
a) attaching at least one rod to at least one deflector;
b) attaching a metal tube in an insulator to define a bore for receiving the rod;
c) attaching the insulator to a base;
d) attaching a filament assembly to the base;
e) sliding the rod into the tube to mount the deflector to the base; and
f) attaching the rod to the tube.

16. The method of claim 15, wherein the step of mounting the rod to the deflector includes positioning the first end of the rod in a hole within the deflector and brazing the rod to the deflector.

17. The method of claim 15, wherein the step of attaching the insulator to the base includes:
metalizing one end of an outer surface of the insulator;
positioning the metalized end of the insulator in a bore in the base; and
brazing the metalized surface of the insulator to the base.

18. The method of claim 15, wherein the step of attaching the tube in the insulator includes:
inserting the tube in a bore in the insulator;
welding the tube to the insulator.

19. The method of claim 18, wherein the step of attaching the rod to the tube includes:
crimping the rod and the tube together.

20. The method of claim 15 further including:
as the rod is slid into the tube, setting and aligning the deflector;
performing the step of attaching the rod to the tube after the deflector has been set in a preselected position with a preselected alignment.
